(19) United States
(12) Patent Application Publication
(10) Pub. No.: US 2001/0022264 A1
(43) Pub. Date: Sep. 20, 2001

(54) Start motor assembly

(75) Inventors: Pierre Merlin, Fontaine Les Dijon (FR); Serge Paggi, Ruffey Les Echirey (FR); Thierry Fort, Rueil-Malmaison (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Schneider Electric Industries SA, RUEIL-MALMAISON (FR)

(21) Appl. No.: 09/802,912

(22) Filed: Mar. 12, 2001

(30) Foreign Application Priority Data
Mar. 17, 2000 (FR) 00 03563

(51) Int. Cl. H01H 9/20

(52) U.S. Cl. 200/50.32

(57) ABSTRACT

A switch assembly, particularly for a start-motor including a protection device and a contactor device, and an intermediate component for mechanical association and electrical interconnection between these two devices.

The association component 30 has, to adapt a protection device 10 of fixed size to contactor devices 20 of different sizes, an adjustable part 36. The adjustable part 36 is located at the rear of the component 30, which it may be snapped onto in different positions staggered in depth, and offers a lock-on lug 35 located in the direction of the contactor device 20 and fitted with several support forms 39, 40 staggered in height.

The present invention concerns a switch assembly including a protection device and a contactor device, and a component for the mechanical association of the contactor device with the protection device and for electrical interconnection between the two devices, the component being intended to be placed in an intermediate position between the two devices and to be connected to power terminals of the two devices by respective pins pointing in opposite directions.

The protection device may for example be a circuit breaker device or a fuse carrier device. An assembly is described in the document EP-588 712. The mechanical association of the contactor device with the circuit breaker device is achieved particularly by the engagement of a lug of the association component in a channel provided at the rear of the contactor device. Such an association component is specific to a single size of contactor device and, in order to fit different types of contactor devices to a same circuit breaker device, the only recourse is to use different intermediate components.

A purpose of the invention is to allow the easy and cheap assembly of switch assemblies, particularly for a motor-starter.

According to the invention, the association component has position adaptation means, particularly for fitting a protection device of fixed size to contactor devices of different sizes or for adjusting the relative position of the two devices of the switch assembly.

The association component preferably includes an insulating body fitted at the rear of at least one support element of one of the devices, the adaptation means allowing the choice of position of this support element in depth and/or in height. These adaptation means may comprise at least one lock-on lug which is intended to fix the association component to the contactor device and/or the protection device and which has a variable position, particularly by being provided on an adjustable part fixed to the association component, for example able to be snapped onto it in different positions staggered in depth, and/or fitted with support forms staggered in height.

It may be understood that the solution provided allows the cost of the switch assembly to be reduced.

The description will be given below of a non-restrictive embodiment of the invention, with reference to the appended drawings.

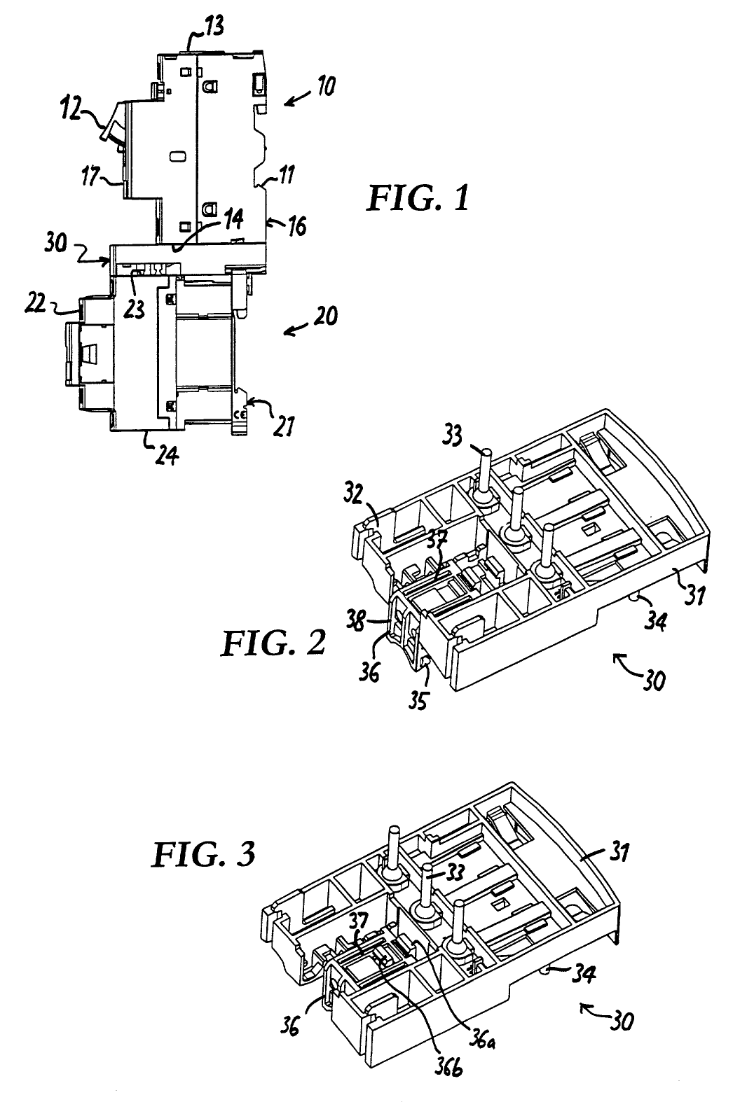

FIG. 1 shows in side view a motor-starter assembly according to the invention.

FIGS. 2 and 3 are larger scale perspective views of the association component of the association component of the assembly in FIG. 1, the component being shown in two states allowing contactors of different sizes to be fitted.

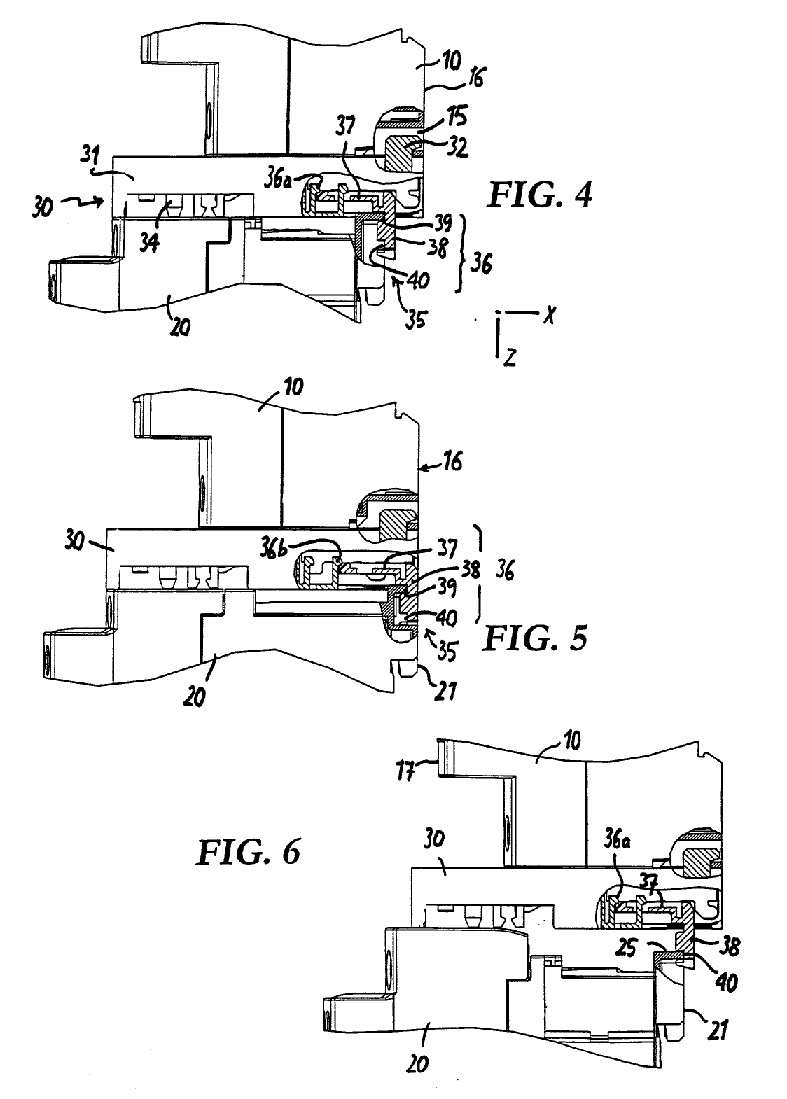

FIGS. 4 to 6 show in side view a part of an assembly according to the invention, with fitting to a same circuit breaker of contactors of different sizes.

The assembly in FIG. 1 includes a circuit breaker 10 and a contactor 20 assembled by means of an intermediate component 30. The circuit breaker 10 may be fixed at its rear part to a support such as a rail standardised by fixing elements 11 and comprises at its front part power-on and power-off buttons 12. It has furthermore upstream power terminals (top) 13 and downstream power terminals (bottom) 14. The contactor 20 has rear faces 21 and front faces 22, and upstream power terminals (top) 23 and downstream power terminals (bottom) 24. The intermediate component 30 is of relatively flat shape and includes an insulating body 31, and conductors integral with the body and connected by up pins 33 to the bottom terminals 14 of the circuit breaker and by down pins 34 to the top terminals 23 of the contactor. The pins shown are fixed, but they could be adjustable so as to adapt to variable inter-terminal spacing.

The component 30 is kept on the circuit breaker by retaining elements such as lugs 32 engaging with channels 15, for example slots, provided in the casing of the circuit breaker (see FIG. 4), and by tightening the pins 33 in the terminals 14. The contactor is fixed under the component 30 by a lug 35 provided at the rear of a component 36 snapped on in an adjustable manner at the rear of the component 30, and by tightening the pins 34 in the terminals 23. Adjusting the position of the component 38 makes it possible to adjust the position of the lug 35 along the direction X, that is in depth.

The detachable component 36 is in the shape of a set square fitted with a horizontal flange 37 for retention in the component 30 and a vertical flange 38 for supporting the contactor. The horizontal flange 37 is engaged against a notch, stop or similar support 36a, 36b of the body 31 of the component 30 and the vertical support flange 38 is fitted with two notches or other similar forms 39,40 onto which the rear part of the casing of the contactor locks. The component 30 is shown in the pushed back position in FIG. 2 and in the forward position in FIG. 3, the stop 36b being located further back than the stop 36a. The two notches 39, 40 allow the assembly of ribs 25 or of other forms of the contactor located at a variable height depending on the type of contactor relative to its upper face 26; this upper face 26 is defined by various stop elements and it is applied against the bottom face of the component 30. The notches 39, 40 make it possible therefore to adapt the association component to the size of the contactor along the direction Z, that is in height.

In FIG. 4 can be seen the assembly of a contactor of small size (in depth) by a rib 25 engaged in the upper notch 39; in FIG. 5 the assembly of a contactor of large size (in depth), the component 30 being respectively in the forward position and the pushed back position. In these two cases, the contactor engages by a rib 25 with the upper notch 39 of the component 30. In FIG. 6 is shown the assembly of a contactor of large size (in height), i.e. the front part of which is higher than the rear part, its rib 25 is then located lower relative to its upper face 26 and is engaged in the bottom notch 40 of the component 30.

The invention is also aimed at the possibility of adjusting the position of the contactor relative to the circuit breaker by notches or adjustable parts associated with the component 30 on the circuit breaker side. On the other hand, the male and female forms which have been described may of course be reversed. According to circumstances, the adaptation may be operated on the position of the rear face 21 of the contactor relative to that of the rear face of the circuit breaker, or of the front face 22 of the contactor relative to the front face of the circuit breaker. The circuit breaker described may be replaced by a fuse carrier device or another similar protection device.

1. A switch assembly including a protection device (10) and a contactor device (20), and a component (30) for the mechanical association of the contactor device with the protection device and for electrical interconnection between the two devices, the component being intended to be placed in an intermediate position between the two devices and to be connected to power terminals of the two devices by respective pins pointing in opposite directions, characterised by the fact that the association component (30) has means for adapting a protection device (10) of fixed size to contactor devices (20) of different sizes.

2. An assembly according to claim 1, characterised in that the association component (30) includes an insulating body (31) fitted at the rear with at least one support element (39, 40) of one of the devices, the adaptation means allowing the choice of position of the support element in depth (X).

3. An assembly according to claim 1, characterised in that the association component (30) includes an insulating body (31) fitted at the rear with several support elements (39, 40) of one of the devices, the adaptation means allowing the choice of position of the support element in height (Z).

4. A switch assembly including a protection device (10) and a contactor device (20), and a component (30) for the mechanical association of the contactor device with the protection device and for electrical interconnection between the two devices, characterised in that the association component (30) has at the rear adaptation means comprising at least one lug (35) intended to lock the association component onto the contactor device and/or the protection device, the lock-on lug (35) being provided on an adjustable part (36) fixed to the association component and fitted with adjustment means in depth (X).

5. An assembly according to claim 4, characterised in that the adjustable part (36) may be snapped in different positions onto the association component (30) at the rear of it.

6. An assembly according to claim 4, characterised in that the lock-on lug (35) is provided in the direction of the contactor device (20) and is fitted with several support forms (39, 40) staggered in height (Z) and intended to retain additional elements (25) provided at the rear of the contactor device.
